(19) United States
(12) Patent Application Publication
(10) Pub. No.: US 2004/0221735 A1
(43) Pub. Date: Nov. 11, 2004

(54) Bread maker

(75) Inventors: Jae-Ryong Park, Suwon-city (KR); Yong-Hyun Kwon, Suwon-city (KR); Chul Kim, Anyang-city (KR); Tae-Uk Lee, Suwon-city (KR); Han-Jun Sung, Suwon-city (KR); Jang-Woo Lee, Suwon-city (KR); Dong-Bin Lim, Suwon-city (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon City (KR)

(21) Appl. No.: 10/805,339

(22) Filed: Mar. 22, 2004

(30) Foreign Application Priority Data
May 7, 2003 (KR) 2003-28976

(51) Int. Cl. A23L 1/00

(52) U.S. Cl. 99/348

(57) ABSTRACT

A bread maker having an oven compartment, an electrical components compartment, and kneading drums spaced apart from each other inside the oven compartment to knead bread ingredients contained in a mixing bag, each kneading drum including a drum body on which an end of the mixing bag is wound; a first supporter detachably engaging a first end of the drum body having a non-cylindrical cross-section, and engaging a first sidewall of the oven compartment and being rotatably supported by the first sidewall of the oven compartment; and a second supporter detachably engaging a second end of the drum body having a non-cylindrical cross-section, and engaging a second sidewall of the oven compartment and being rotatably supported by the second sidewall of the oven compartment.

### CROSS-REFERENCE TO RELATED APPLICATIONS

This application claims the benefit of Korean Application No. 2003-28976, filed May 7, 2003, in the Korean Intellectual Property Office, the disclosure of which is incorporated herein by reference.

### BACKGROUND OF THE INVENTION

1. Field of the Invention

The present invention relates to a bread maker, and, more particularly, to a bread maker having improved kneading drums.

2. Description of the Related Art

Conventionally, various bread makers have been developed to allow a user to easily make bread automatically.

The conventional bread maker typically includes a main body forming an oven compartment and an electrical components compartment, and a pair of kneading drums that are rotatably provided in parallel inside the oven compartment and spaced apart from each other, and that allow opposite ends of a mixing bag filled with raw materials (ingredients) for bread to be wound thereon.

Each of the kneading drums of the conventional bread maker includes a cylindrical drum body having a first side rotatably supported by an inside wall of the oven compartment and a second side engaged with a drum driving part such as a motor.

A first supporter, rotatably supported by the sidewall of the oven compartment, is provided in one end part of the drum body as one body, and a second supporter, which is extended toward the component compartment and connected to the drum driving part, is provided in the other end part of the drum body as one body.

Because the first and second supporters are formed in the drum body as one body, the kneading drum of the conventional bread maker is rotatably supported in the oven compartment.

However, because the kneading drums of the conventional bread maker are provided with the first and second supporters formed in the drum body as one body, the kneading drum has to be replaced as a whole when the first and second supporters are replaced.

Thus, there is a need for the first and second supporters to be individually replaceable by detaching the first and second supporters from the kneading drum. Also, when the kneading drums are operated, there is a need for the first and second supporters not to freewheel or separate from the drum body.

### SUMMARY OF THE INVENTION

It is an aspect of the present invention to provide a bread maker having a first supporter and a second supporter that are detachably provided in a drum body of a kneading drum to be replaced, and that do not freewheel or separate from the drum body during operation of the kneading drum.

Additional aspects and/or advantages of the invention will be set forth in part in the description that follows, and, in part, will be obvious from the description, or may be learned by practice of the invention.

To achieve the above and/or other aspects according to the present invention, there is provided a bread maker having an oven compartment, an electrical components compartment, and kneading drums spaced apart from each other inside the oven compartment to knead bread ingredients contained in a mixing bag, each kneading drum including a drum body on which an end of the mixing bag is wound; a first supporter detachably engaging a first end of the drum body having a non-cylindrical cross-section, and engaging a first sidewall of the oven compartment and being rotatably supported by the first sidewall of the oven compartment; and a second supporter detachably engaging a second end of the drum body having a non-cylindrical cross-section, and engaging a second sidewall of the oven compartment and being rotatably supported by the second sidewall of the oven compartment.

The bread maker further includes a drum driving part in the electrical components compartment to rotate the kneading drums.

The drum body has a plurality of holding projections to hold the end of the mixing bag, the holding projections being spaced apart from each other by a predetermined distance along a lengthwise direction of the drum body.

The first supporter has a first engaging shaft inserted into the first end of the drum body having a non-cylindrical cross-section; and a first supporting shaft rotatably supported by the first sidewall of the oven compartment.

The first supporter further includes a first insertion limiting part between the first engaging shaft and the first supporting shaft, the first insertion limiting part having a diameter greater than that of the first engaging shaft and the first supporting shaft.

The second supporter includes a second engaging shaft inserted into the second end of the drum body having a non-cylindrical cross-section; a second supporting shaft rotatably supported by the second sidewall of the oven compartment; and a power transmission shaft projecting from the second supporting shaft toward the electrical components compartment and connecting to the drum driving part.

In an aspect, the second supporter further includes a second insertion limiting part between the second engaging shaft and the second supporting shaft, the second insertion limiting part having a diameter greater than that of the second engaging shaft and the second supporting shaft.

To achieve the above and/or other aspects according to the present invention, there is provided a kneading drum for kneading bread ingredients contained in a mixing bag in a bread maker having an oven compartment, the kneading drum including a drum body on which an end of the mixing bag is wound, the drum body having a non-circular cross-section; a first supporter having a first end with a non-circular cross-section detachably engaging a first end of the drum body having a non-circular cross-section, and having a second end with a circular cross-section rotatably engaging a first sidewall of the oven compartment; and a second supporter having a first end with a non-circular cross-section detachably engaging a second end of the drum body having a non-circular cross-section, and having a second end with a circular cross-section rotatably engaging a second sidewall of the oven compartment.

These, together with other aspects and/or advantages that will be subsequently apparent, reside in the details of construction and operation as more fully hereinafter described and claimed, reference being had to the accompanying drawings forming a part thereof, wherein like numerals refer to like parts throughout.

### BRIEF DESCRIPTION OF THE DRAWINGS

These and/or other objects and advantages of the present invention will become apparent and more readily appreciated from the following description of the preferred embodiments, taken in conjunction with the accompany drawings, of which:

FIG. 1 is a perspective view of a bread maker according to an embodiment of the present invention, with a door thereof opened;

FIG. 2 is a perspective view of a kneading drum of the bread maker in FIG. 1;

FIG. 3 is an exploded perspective view of the kneading drum in FIG. 2; and

FIG. 4 is a view of a mixing bag filled with ingredients for bread and used in the bread maker of FIG. 1.

### DETAILED DESCRIPTION OF THE PREFERRED EMBODIMENT

Hereinafter, an embodiment of the present invention will be described in detail with reference to the attached drawings, wherein the like reference numerals refer to the like elements throughout. The present invention may, however, be embodied in many different forms and should not be construed as being limited to the embodiment set forth herein. Rather, this embodiment is provided so that the present disclosure will be thorough and complete, and will fully convey the concept of the invention to those skilled in the art.

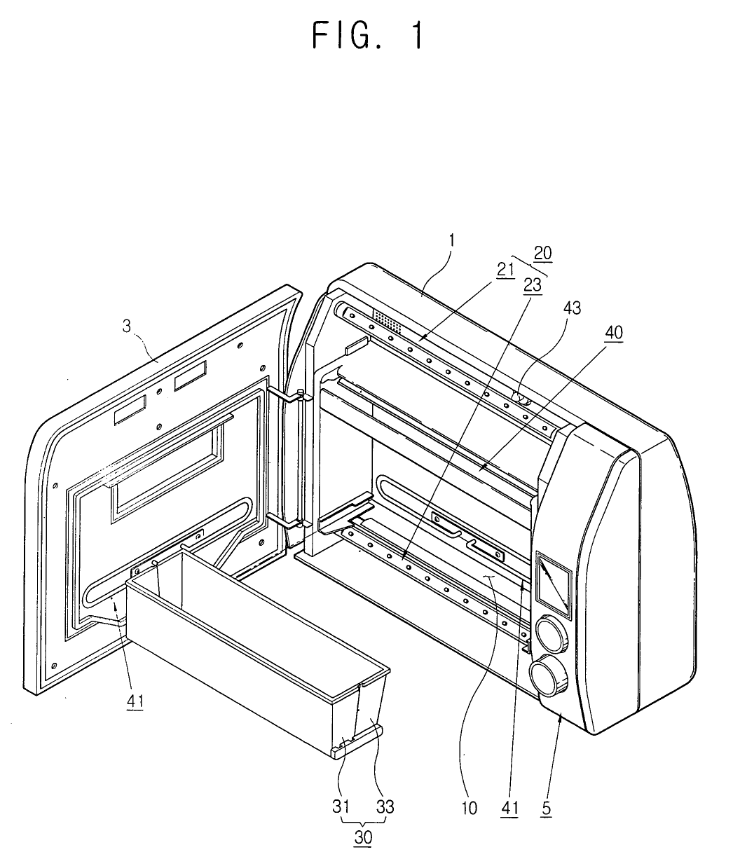

As shown in FIG. 1, the bread maker according to an embodiment of the present invention includes a main body 1 formed with an oven compartment 10 and an electrical components compartment (not shown), a door 3 provided in the front of the main body 1 to open and close a front opening of the oven compartment 10, a control panel 5 provided in the front of the main body 1 to display the operating status of the bread maker, and a pair of kneading drums 20 provided in the oven compartment 10 in parallel and spaced apart from each other. The bread maker according to the present invention further includes a drum driving part (not shown), which is provided in the electrical components compartment, that rotates the kneading drums 20.

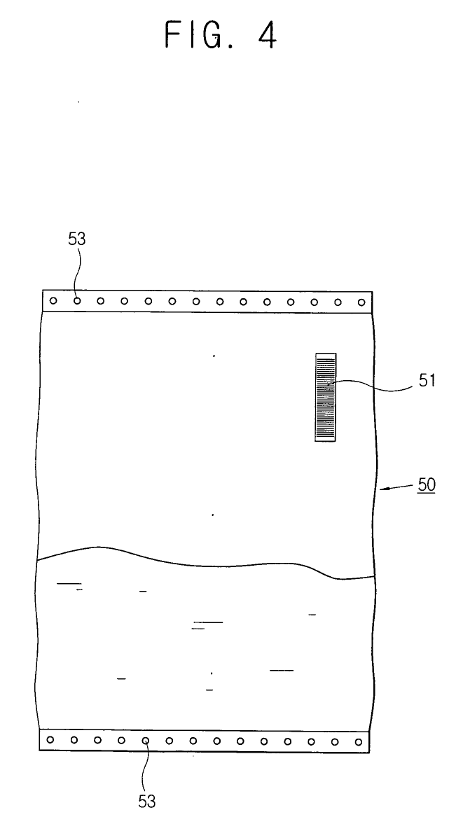

In an upper and a lower part of an inside of the oven compartment 10, an upper kneading drum 21 and a lower kneading drum 23, which form the pair of kneading drums 20, are provided, wherein opposite ends of a mixing bag 50 (refer to FIG. 4) filled with raw materials (ingredients) for bread are wound onto the kneading drums 20. In a lower part of the oven compartment 10, a baking tray 30, which contains completely kneaded ingredients for baking, is provided between the upper kneading drum 21 and the lower kneading drum 23. The baking tray 30 includes a first tray 31 and a second tray 33 having “L”-shaped cross-sections that are symmetrical to one another. The first tray 31 and the second tray 33 combine to form a box with a top opening. In an upper part of the oven compartment 10, a pair of kneading members 40 provided between the upper kneading drum 21 and the baking tray 30 knead dough in the mixing bag and prevent the dough kneaded in the mixing bag 50 from moving beyond the baking tray 30 to the upper kneading drum 21. The dough in the baking tray 30 is baked using heaters 41 in the oven compartment 10 and in the door 3. Behind the upper kneading drum 21 in the upper part of the oven compartment 10 is a bar code scanner 43 that reads a bar code 51 FIG. 4) attached to the mixing bag 50.

A drum driving part (not shown) is provided in the electrical components compartment (not shown) to rotate the kneading drums 20 in forward and reverse directions, and includes a driving motor (not shown) rotating the lower kneading drum 23 and a belt (not shown) linking the lower kneading drum 23 and the upper kneading drum 21 to rotate together. However, the driving motor may rotate the upper kneading drum 21.

The upper kneading drum 21 and the lower kneading drum 23 have similar constructions.

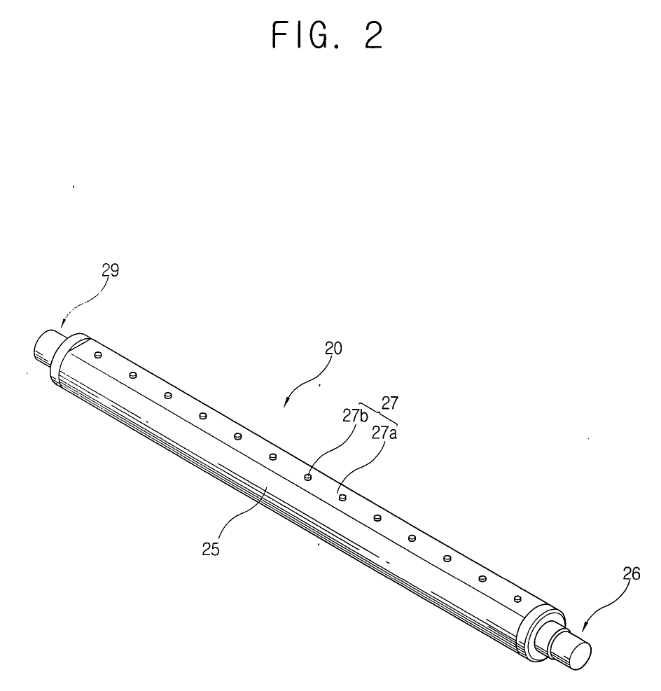

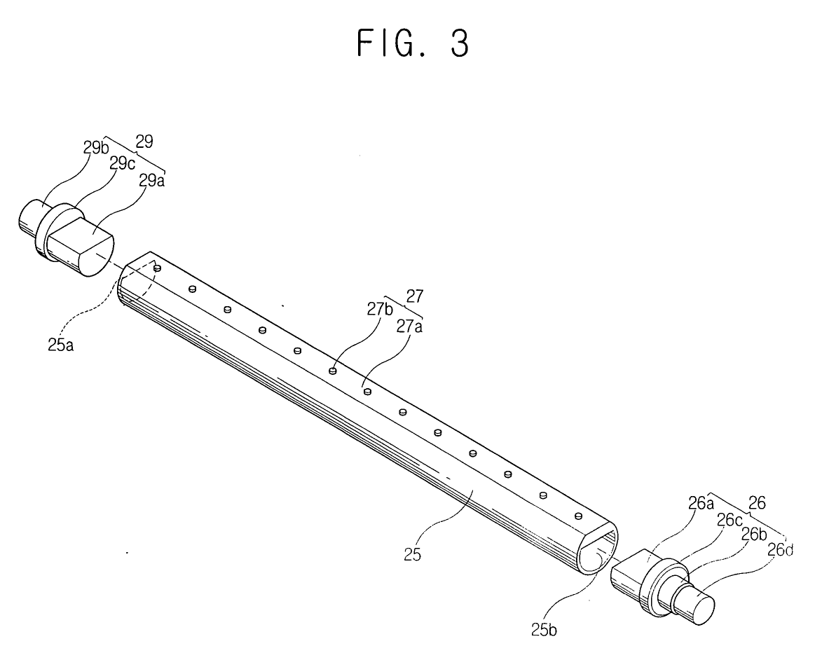

As shown in FIGS. 2 and 3, each of the kneading drums 20, according to the embodiment of the present invention, includes a drum body 25 rotatably engaged with the oven compartment 10, a first supporter 29 and a second supporter 26, which are detachably connected to the drum body 25 and rotatably connected to a sidewall of the oven compartment 10 and driven by the drum driving part (not shown) provided in the electrical components compartment (not shown).

The drum body 25 has a cylindrical shape with a predetermined length. In one portion of the drum body 25, a holder 27 holding an end of the mixing bag 50 is provided. As shown in FIG. 3, in a first end of the drum body 25 is formed a first accommodator 25a to accommodate a first engaging shaft 29a (described below) of the first supporter 29, and in a second end of the drum body 25 is formed a second accommodator 25b to accommodate a second engaging shaft 26a (described below) of the second supporter 26.

The holder 27 has a mixing bag contacting part 27a, which is formed in a cylindrical surface of the drum body 25 as a plane shape along a lengthwise direction of the drum body 25, and a plurality of holding projections 27b projecting from the mixing bag contacting part 27a and spaced apart from each other by a predetermined distance along the lengthwise direction of the drum body 25. The holder 27 may be attached and detached from the drum body 25, and may be slidably engaged with the drum body 25 along the lengthwise direction of the drum body 25.

Thus, holding holes 53 (FIG. 4) of the mixing bag 50 can be easily held in the holding projections 27b formed in the mixing bag contacting part 27a such that one of the ends of the mixing bag 50, formed with a plurality of holding holes 53, contacts the mixing bag contacting part 27a.

The first engaging shaft 29a of the first supporter 29 is inserted into a first end of the drum body 25 having a non-circular cross-section, and a first supporting shaft 29b is rotatably supported by a first sidewall of the oven compartment 10. The first supporter 29 has a first insertion limiting part 29c between the first engaging shaft 29a and the first supporting shaft 29b with a diameter greater than that of the first engaging shaft 29a and the first supporting shaft 29b.

The first engaging shaft 29a, which has a non-circular cross-section, connects to the first accommodator 25a of the drum body 25. The first engaging shaft 29a is pressed and inserted into the first accommodator 25a to fit into the first accommodator 25a. Also, the first engaging shaft 29a has a non-circular cross-section, which is formed by cutting away one part of a cylindrical shape. However, the first engaging shaft 29a may have a polygonal cross-section such as a triangular or rectangular cross-section. Therefore, the first supporter 29 is easily combined to the first end of the drum body 25. After the first engaging shaft 29a is inserted into the first accommodator 25a, the first engaging shaft 29a and the first accommodator 25a may be screw-engaged using screws or pins, for example.

The first supporting shaft 29b is rotatably inserted into the first sidewall of the oven compartment 10 and supports the first end of the drum body 25. The first supporting shaft 29b may engage a bearing (not shown) provided in the first sidewall of the oven compartment 10 for smooth rotation of the drum body 25.

The first insertion limiting part 29c contacts the first end of the drum body 25 through the first engaging shaft 29a and the first sidewall of the oven compartment 10 through the first shaft 29b. The first insertion limiting part 29c limits the distance the first supporter 29 can be inserted into the drum body 25.

The first supporter 29 rotatably supports the drum body 25 by engaging the first accommodator 25a and the first sidewall of the oven compartment 10. Also, because the first supporter 29 detachably engages the first accommodator 25a of the drum body 25 having a non-circular cross-section, the first supporter 29 does not freewheel or separate from the drum body 25 while the kneading drum operates, and can be detached from the drum body 25 and replaced, as needed.

The second supporter 26 includes the second engaging shaft 26a, which is inserted into a second end of the drum body 25 having a non-circular cross-section, a second supporting shaft 26b rotatably supported by the second sidewall of the oven compartment 10, and a power transmission shaft 26d extending from the second supporting shaft 26b toward the electrical components compartment and connecting to the drum driving part. The second supporter 26 has a second insertion limiting part 26c between the second engaging shaft 26a and the second supporting shaft 26b, with a diameter greater than that of the second engaging shaft 26a and the second shaft 26b.

The second engaging shaft 26a, which has a non-circular cross-section, is inserted into and engages the second accommodator 25b of the drum body 25. When the second engaging shaft 26a engages the second accommodator 25b, the second engaging shaft 26a is pressed and inserted into the second accommodator 25b to fit into the second accommodator 25b. Also, the second engaging shaft 26a has a non-circular cross-section, which is formed by cutting away one part of a cylindrical shape. However, the second engaging shaft 26a may have a polygonal cross-section such as a triangular or rectangular cross-section. Therefore, the second supporter 26 is easily combined with the second end of the drum body 25. After the second engaging shaft 26a is inserted into the second accommodator 25b, the second engaging shaft 26a and the second accommodator 25b may be screw-engaged using screws or pins, for example.

The second supporting shaft 26b is rotatably inserted into the second sidewall of the oven compartment 10 and supports the second end of the drum body 25. The second supporting shaft 26b may engage a bearing (not shown) provided in the second sidewall of the oven compartment 10 for smooth rotation of the drum body 25.

The power transmission shaft 26d projects outward from the second supporting shaft 26b, and engages the belt (not shown) of the drum driving part (not shown) on a circumference of the power transmission shaft 26d. The power transmission shaft 26d of the second supporter 26, which is coupled with a rotation shaft (not shown) of the driving motor (not shown), of the upper kneading drum or the lower kneading drum 23 engages the rotation shaft of the driving motor by a coupling, etc.

The second insertion limiting part 26c contacts the second end of the drum body 25 through the second accommodator 25b of the drum body 25 and the second engaging shaft 26a, and the second sidewall of the oven compartment 10 through the second supporting shaft 26b.

The second supporter 26 rotatably supports the drum body 25 by engaging the second accommodator 25b of the drum body 25 and the second sidewall of the oven compartment 10. Also, because the second supporter 26 detachably engages the second accommodator 25b of the drum body 25 having a non-circular cross-section, the second supporter 26 does not freewheel or separate from the drum body 25 while the kneading drum operates, and can be detached from the drum body 25 and replaced, as needed.

The kneading drums 20 of the bread maker according to the present invention each includes the drum body 25 allowing an end of the mixing bag 50 to be wound thereon, the first supporter 29 inserted into one end of the drum body 25 having a non-circular cross-section, and the second supporter 26 inserted into the. other end of the drum body 25 having a non-circular cross-section. Thus, the first supporter 29 and the second supporter 26 do not freewheel or separate from the drum body 25, and can be detached from the drum body 25 and replaced, as necessary.

As described above, according to the present invention, the first supporter 29 and the second supporter 26 can be prevented from freewheeling or separating from the drum body 25, and can be detached from the drum body 25 and replaced, as necessary.

Although an embodiment of the present invention has been shown and described, it will be appreciated by those skilled in the art that changes may be made in this embodiment without departing from the principles and spirit of the invention, the scope of which is defined in the appended claims and their equivalents.

What is claimed is:

1. A bread maker having an oven compartment, an electrical components compartment, and kneading drums spaced apart from each other inside the oven compartment to knead bread ingredients contained in a mixing bag, each kneading drum comprising:
a drum body on which an end of the mixing bag is wound;
a first supporter detachably engaging a first end of the drum body having a non-cylindrical cross-section, and engaging a first sidewall of the oven compartment and being rotatably supported by the first sidewall of the oven compartment; and
a second supporter detachably engaging a second end of the drum body having a non-cylindrical cross-section, and engaging a second sidewall of the oven compartment and being rotatably supported by the second sidewall of the oven compartment.

2. The bread maker according to claim 1, further comprising a drum driving part in the electrical components compartment to rotate the kneading drums.

3. The bread maker according to claim 2, wherein the drum body comprises a plurality of holding projections to hold the end of the mixing bag, the holding projections being spaced apart from each other by a predetermined distance along a lengthwise direction of the drum body.

4. The bread maker according to claim 2, wherein the first supporter comprises:
a first engaging shaft, having a non-cylindrical cross-section, inserted into the first end of the drum body; and
a first supporting shaft rotatably supported by the first sidewall of the oven compartment.

5. The bread maker according to claim 4, wherein the first supporter further comprises a first insertion limiting part between the first engaging shaft and the first supporting shaft, the first insertion limiting part having a diameter greater than that of the first engaging shaft and the first supporting shaft.

6. The bread maker according to claim 5, wherein the second supporter comprises:
a second engaging shaft, having a non-cylindrical cross-section, inserted into the second end of the drum body;
a second supporting shaft rotatably supported by the second sidewall of the oven compartment; and
a power transmission shaft projecting from the second supporting shaft toward the electrical components compartment and connecting to the drum driving part.

7. The bread maker according to claim 6, wherein the second supporter further comprises a second insertion limiting part between the second engaging shaft and the second supporting shaft, the second insertion limiting part having a diameter greater than that of the second engaging shaft and the second supporting shaft.

8. The bread maker according to claim 7, wherein the first insertion limiting part limits the distance the first supporter can be inserted into the drum body, and the second insertion limiting part limits the distance the second supporter can be inserted into the drum body.

9. The bread maker according to claim 4 wherein the second supporter comprises:
a second engaging shaft, having a non-cylindrical cross-section, inserted into the second end of the drum body;
a second supporting shaft rotatably supported by the second sidewall of the oven compartment; and
a power transmission shaft projecting from the second supporting shaft toward the electrical components compartment and connecting to the drum driving part.

10. The bread maker according to claim 9, wherein the drum body comprises a first accommodator having a non-circular cross-section to accommodate the first engaging shaft of the first supporter, the first engaging shaft being pressed and inserted into the first accommodator to fit into the first accommodator, thereby preventing the first supporter from freewheeling or separating from the drum body during operation of the kneading drums.

11. The bread maker according to claim 10, wherein the drum body comprises a second accommodator having a non-circular cross-section to accommodate the second engaging shaft of the second supporter, the second engaging shaft being pressed and inserted into the second accommodator to fit into the second accommodator, thereby preventing the second supporter from freewheeling or separating from the drum body during operation of the kneading drums.

12. The bread maker according to claim 9 wherein the second supporter further comprises a second insertion limiting part between the second engaging shaft and the second supporting shaft, the second insertion limiting part having a diameter greater than that of the second engaging shaft and the second supporting shaft.

13. The bread maker according to claim 9, wherein the first engaging shaft has a polygonal cross-section, and the second engaging shaft has a polygonal cross-section.

14. The bread maker according to claim 9, further comprising a bearing in the first sidewall of the oven compartment, the first supporting shaft engaging the bearing to smoothly rotate the drum body, and a bearing in the second sidewall of the oven compartment, the second supporting shaft engaging the bearing to smoothly rotate the drum body.

15. The bread maker according to claim 9, wherein the first supporting shaft supports the first end of the drum body, and the second supporting shaft supports the second end of the drum body.

16. The bread maker according to claim 4, wherein the drum body comprises a first accommodator having a non-circular cross-section to accommodate the first engaging shaft of the first supporter, the first engaging shaft being pressed and inserted into the first accommodator to fit into the first accommodator, thereby preventing the first supporter from freewheeling or separating from the drum body during operation of the kneading drums.

17. The bread maker according to claim 2, wherein the second supporter comprises:
a second engaging shaft, having a non-cylindrical cross-section, inserted into the second end of the drum body;
a second supporting shaft rotatably supported by the second sidewall of the oven compartment; and
a power transmission shaft projecting from the second supporting shaft toward the electrical components compartment and connecting to the drum driving part.

18. The bread maker according to claim 17, wherein the second supporter further comprises a second insertion limiting part between the second engaging shaft and the second supporting shaft, the second insertion limiting part having a diameter greater than that of the second engaging shaft and the second supporting shaft.

19. The bread maker according to claim 1, wherein the drum body comprises a holder detachably connected to the drum body to hold the end of the mixing bag, the holder comprising:
a mixing bag contacting part formed in a cylindrical surface of the drum body as a plane shape along a lengthwise direction of the drum body; and
a plurality of holding projections projecting from the mixing bag contacting part to engage and hold the end of the mixing bag, the holding projections being spaced apart from each other by a predetermined distance along the lengthwise direction of the drum body.

20. A kneading drum for kneading bread ingredients contained in a mixing bag in a bread maker having an oven compartment, the kneading drum comprising:
a drum body on which an end of the mixing bag is wound, the drum body having a non-circular cross-section;
a first supporter having a first end with a non-circular cross-section detachably engaging a first end of the drum body having a non-circular cross-section, and having a second end with a circular cross-section rotatably engaging a first sidewall of the oven compartment; and
a second supporter having a first end with a non-circular cross-section detachably engaging a second end of the drum body having a non-circular cross-section, and having a second end with a circular cross-section rotatably engaging a second sidewall of the oven compartment.

21. The kneading drum according to claim 20, wherein the first supporter comprises:
a first engaging shaft inserted into the first end of the drum body having a non-cylindrical cross-section; and
a first supporting shaft rotatably supported by the first sidewall of the oven compartment.

22. The kneading drum according to claim 21, wherein the first supporter further comprises a first insertion limiting part between the first engaging shaft and the first supporting shaft, the first insertion limiting part having a diameter greater than that of the first engaging shaft and the first supporting shaft.

23. The kneading drum according to claim 20, wherein the second supporter comprises:
a second engaging shaft inserted into the second end of the drum body having a non-cylindrical cross-section;
a second supporting shaft rotatably supported by the second sidewall of the oven compartment; and
a power transmission shaft projecting from the second supporting shaft toward the electrical components compartment and connecting to the drum driving part.

24. The kneading drum according to claim 23, wherein the second supporter further comprises a second insertion limiting part between the second engaging shaft and the second supporting shaft, the second insertion limiting part having a diameter greater than that of the second engaging shaft and the second supporting shaft.

25. A bread maker having an oven compartment, an electrical components compartment, and kneading drums spaced apart from each other inside the oven compartment to knead bread ingredients contained in a mixing bag, each kneading drum comprising:
a drum body, having a non-circular cross-section, on which an end of the mixing bag is wound, the drum body having a first accommodator and a second accommodator;
a first supporter detachably engaging a first end of the drum body and engaging a first sidewall of the oven compartment, and being rotatably supported by the first sidewall of the oven compartment, the first supporter having a first engaging shaft; and
a second supporter detachably engaging a second end of the drum body and engaging a second sidewall of the oven compartment, and being rotatably supported by the second sidewall of the oven compartment, the second supporter having a second engaging shaft,
the first engaging shaft, having a non-cylindrical cross-section, being inserted into the first end of the drum body,
the second engaging shaft, having a non-cylindrical cross-section, being inserted into the second end of the drum body,
the first accommodator having a non-circular cross-section to accommodate the first engaging shaft of the first supporter, the first engaging shaft being pressed and inserted into the first accommodator to fit into the first accommodator, thereby preventing the first supporter from freewheeling or separating from the drum body during operation of the kneading drums, and
the second accommodator having a non-circular cross-section to accommodate the second engaging shaft of the second supporter, the second engaging shaft being pressed and inserted into the second accommodator to fit into the second accommodator, thereby preventing the second supporter from freewheeling or separating from the drum body during operation of the kneading drums.
